(19) United States
(12) Patent Application Publication
(10) Pub. No.: US 2008/0130785 A1
(43) Pub. Date: Jun. 5, 2008

(54) Frequency and temperature dependent pre-distortion

(75) Inventor: Victor S. Reinhardt, Rancho Palos Verdes, CA (US)

Correspondence Address: Raytheon Company;Patent Docket Administration, P.O. Box 902, E04/N119, 2000 E. El Segundo Blvd., El Segundo, CA, 90245-0902, US

(73) Assignee: Raytheon Company

(21) Appl. No.: 11/633,223

(22) Filed: Dec. 4, 2006

(51) Int. Cl. H04B 17/00; H04B 1/04

(52) U.S. Cl. 375/296; 455/114.3

(57) ABSTRACT

A frequency and temperature dependent pre-distortion device. The novel pre-distortion device includes a plurality of pre-distortion generators, each pre-distortion generator adapted to receive an input signal and output a pre-distorted signal, and a pre-distortion selector for selecting one of the pre-distortion generators in accordance with a frequency of the input signal and/or a temperature. Each pre-distortion generator is adapted to compensate for distortions produced in a particular frequency range and/or temperature range. In an illustrative embodiment, the pre-distortion generators are implemented using digital look-up tables.

This invention was made with Government support under a Government contract. The Government may have certain rights in this invention.

### BACKGROUND OF THE INVENTION

1. Field of the Invention

The present invention relates to signal processing. More specifically, the present invention relates to pre-distortion techniques.

2. Description of the Related Art

Intermodulation distortion (IMD) is a critical limitation on the performance of radar, communications, navigation, and other systems. IMD is caused by non-linearities in the analog components that make up these systems. The linearity that can be achieved in these components is limited by both state-of-the-art considerations and fundamental conflicts between linearity and noise figure constraints. Reducing IMD by compensating or pre-distorting for analog component non-linearities is of great importance in developing systems with improved performance.

A transmit system for radar, communications, navigation, and other applications typically includes a frequency synthesizer, a modulator, and follow-on RF (radio frequency) modules (such as upconverters and power amplifiers). In agile frequency systems, where the frequency is hopped or ramped over a frequency range, a direct digital synthesizer (DDS) is a preferred synthesizer because of its small size, fast response, and high performance. Prior art techniques for reducing IMD include spur reduction techniques in DDSs, pre-distortion in modulators, and linearizers in follow-on RF modules. All of these techniques are aimed at reducing IMD by reducing voltage non-linearities in the analog components of these modules.

Unfortunately, these non-linearities are often a function of frequency and bandwidth, as well as temperature. In general, correcting for frequency dependent non-linearities in wideband systems is very difficult to implement. Simple frequency compensation has been achieved in wideband systems using analog linearizers, but the ability to achieve frequency compensation is severely limited by available characteristics in analog components. Also, the mechanics of correcting for frequency dependent non-linearities are not completely understood for wide bandwidth systems, and this has limited the success of such linearizers or modulation pre-distorters. Some temperature compensation can also be achieved in wideband analog linearizers, but this compensation is also limited by the state-of-the-art of available analog components.

Hence, a need exists in the art for an improved system or method for reducing frequency dependent intermodulation distortion.

### SUMMARY OF THE INVENTION

The need in the art is addressed by the frequency and temperature dependent pre-distortion device of the present invention. The novel pre-distortion device includes a plurality of pre-distortion generators, each pre-distortion generator adapted to receive an input signal and output a pre-distorted signal, and a pre-distortion selector for selecting one of the pre-distortion generators in accordance with a frequency of the input signal and/or a temperature. Each pre-distortion generator is adapted to compensate for distortions produced in a particular frequency range and/or temperature range. In an illustrative embodiment, the pre-distortion generators are implemented using digital look-up tables.

### BRIEF DESCRIPTION OF THE DRAWINGS

FIG. 1a is a graph of an illustrative V(Vₚ) curve that characterizes the instantaneous voltage distortion in a direct digital synthesizer.

FIG. 1b is a graph of an illustrative AM/AM distortion curve Aₒ(Aᵢ).

FIG. 1c is a graph of an illustrative AM/PM distortion curve φ(Aᵢ).

FIG. 2 is a graph of an illustrative chirp waveform illustrating the concepts of the present invention.

FIG. 3 is a simplified block diagram of a DDS with frequency dependent pre-distortion designed in accordance with an illustrative embodiment of the present invention.

FIG. 4 is a simplified block diagram of a direct digital synthesizer and modulator system with frequency and temperature dependent pre-distortion designed in accordance with an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Non-linearities are typically characterized by either instantaneous voltage distortion or RF envelope AM/AM (amplitude to amplitude) and AM/PM (amplitude to phase) distortion. Non-linearities in direct digital synthesizers (DDSs) are due principally to instantaneous voltage distortion in the digital-to-analog-converters (DACs) used in these devices. RF envelope AM/AM and AM/PM distortion occurs in RF amplifiers and other active devices.

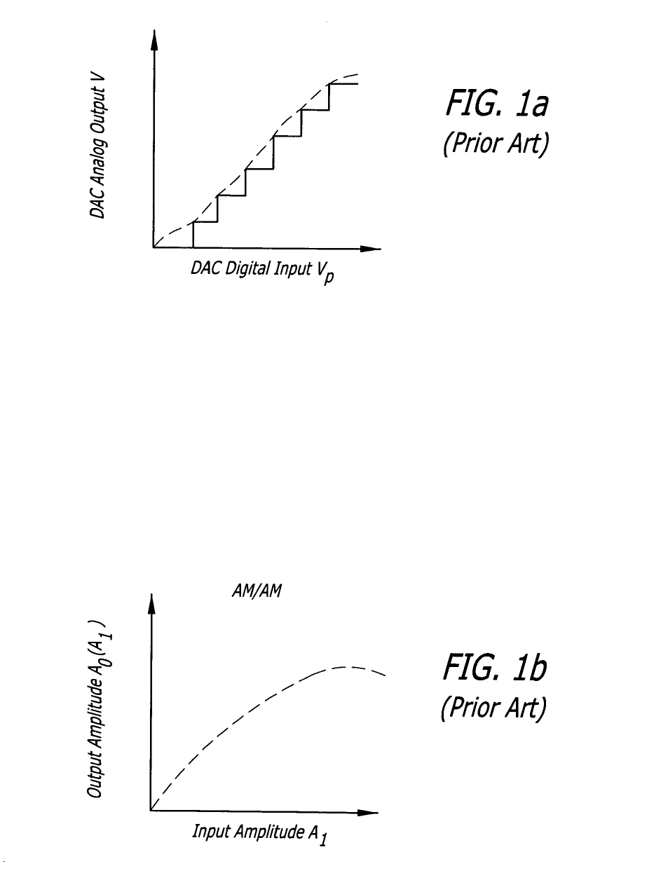

FIG. 1a is a graph of an illustrative V(Vₚ) curve that characterizes the instantaneous voltage distortion in a DDS. A DDS digitally generates a waveform and then converts it to analog using a DAC. The input voltage Vₚ is a digital voltage word input to the DAC and the output voltage V is the analog voltage output by the DAC. Non-linearities are a particular problem in wideband DDSs that require high speed DACs. These non-linearities in high speed DACs limit the effective number of bits to a value well below the number of quantization bits. Prior art techniques for reducing distortion in DDSs include jitter injection and other randomization techniques that reduce spurs at the price of increased phase noise.

In a device operating at an RF frequency fₒ, AM/AM distortion can be represented by a curve Aₒ(Aᵢ), where Aₒ is the output RF signal amplitude and Aᵢ is the input signal amplitude. AM/PM distortion can be represented by a curve φ(Aᵢ), where φ is the output RF signal phase shift relative to the input phase. FIG. 1b is a graph of an illustrative AM/AM distortion curve Aₒ(Aᵢ), and FIG. 1c is a graph of an illustrative AM/PM distortion curve φ(Aᵢ).

Prior art techniques for reducing distortion in RF amplifiers and other active devices involve using a linearizer preceding the non-linear devices. A linearizer generates amplitude and phase pre-distortion to compensate for the AM/AM and AM/PM distortion to produce composite Aₒ(Aᵢ) and φ(Aᵢ) curves with lower AM/AM and AM/PM distortion. Generally for wideband systems, these linearizers are analog devices. Digitally implemented linearizers can operate in low and medium system bandwidths, but these devices are limited by analog-to-digital-converter and digital device speeds. Signal modulators used in communications and navigation systems can use digital pre-distortion similar in function to that used in digital linearizers, but these devices are also limited to low and medium bandwidth systems by device speeds.

These distortion curves V(Vₚ), Aₒ(Aᵢ), and φ(Aᵢ) typically change over frequency and temperature. This makes it very difficult to implement pre-distortion in wideband systems. Simple frequency compensation has been achieved using analog linearizers, but compensation has been severely limited by the available characteristics in analog components. Furthermore, the mechanics of frequency dependent non-linearities are not completely understood and this has limited the success of such linearizers or modulation pre-distorters.

The present invention provides a novel method for reducing frequency dependent IMD in wideband agile frequency systems. Agile systems utilize waveforms such as a frequency chirp (commonly used in radar applications) or a frequency hop signal (commonly used in spread spectrum communications systems) that have very small instantaneous bandwidths compared with their overall hopping or ramped bandwidths. This greatly simplifies the problem of providing frequency dependent compensation for system IMD. The novel scheme switches between a number of non-frequency dependent non-linear correction tables as the frequency of the signal changes to reproduce the effect of wideband frequency dependent correction. Because the instantaneous bandwidth is narrow, this switching and the digital pre-distortion itself do not require device speeds comparable to the overall system bandwidth.

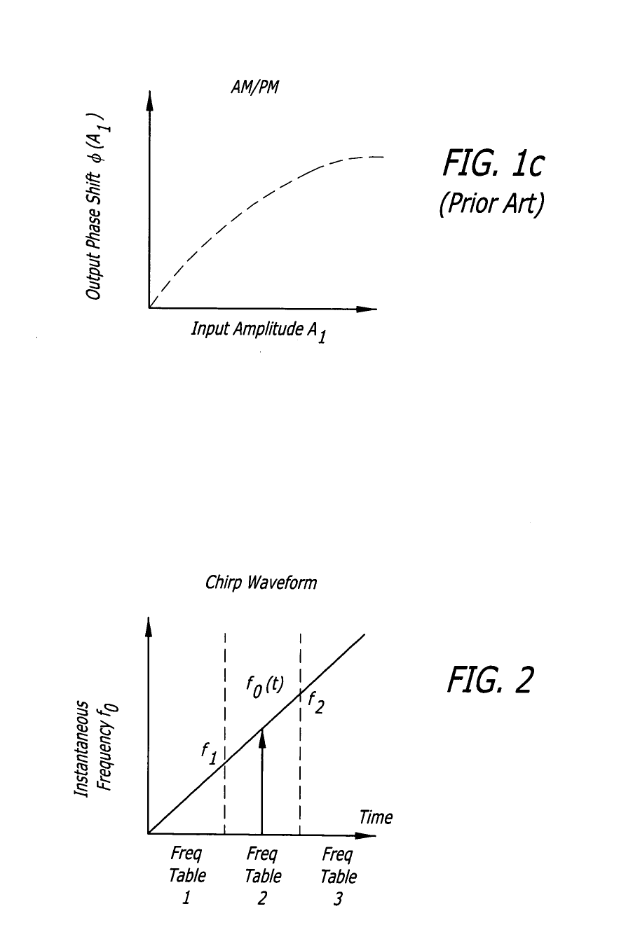

FIG. 2 is a graph of an illustrative chirp waveform illustrating the concepts of the present invention for a chirp waveform. A chirp waveform ramps the output frequency in time. At any point in time, the instantaneous bandwidth is small. System non-linearities at that time can therefore be characterized by a simple non-frequency dependent distortion curve at the instantaneous frequency fₒ. For a hopped waveform, the frequency changes randomly instead of in a systematic chirp, however the principal is the same because the instantaneous bandwidth should again be small. In accordance with the teachings of the present invention, frequency dependent pre-distortion can be applied by using a plurality of pre-distortion tables, each table covering a different sub-band of the overall frequency bandwidth. Each table stores pre-distortion values designed to compensate for the average IMD generated over its sub-band. The table is used when the instantaneous frequency fₒ of an input signal falls within its sub-band. In the illustrative example of FIG. 2, the overall bandwidth is divided into M=3 frequency bands. When the frequency of the input signal is less than f₁, a first pre-distortion table is used. When the frequency of the input signal is between f₁ and f₂, a second pre-distortion table is used. When the frequency of the input signal is greater than f₂, a third pre-distortion table is used. The number of tables M can vary depending on the application. In general, an effective pre-distortion system can be implemented using only a small number of tables since the change in non-linearities with frequency is usually slow.

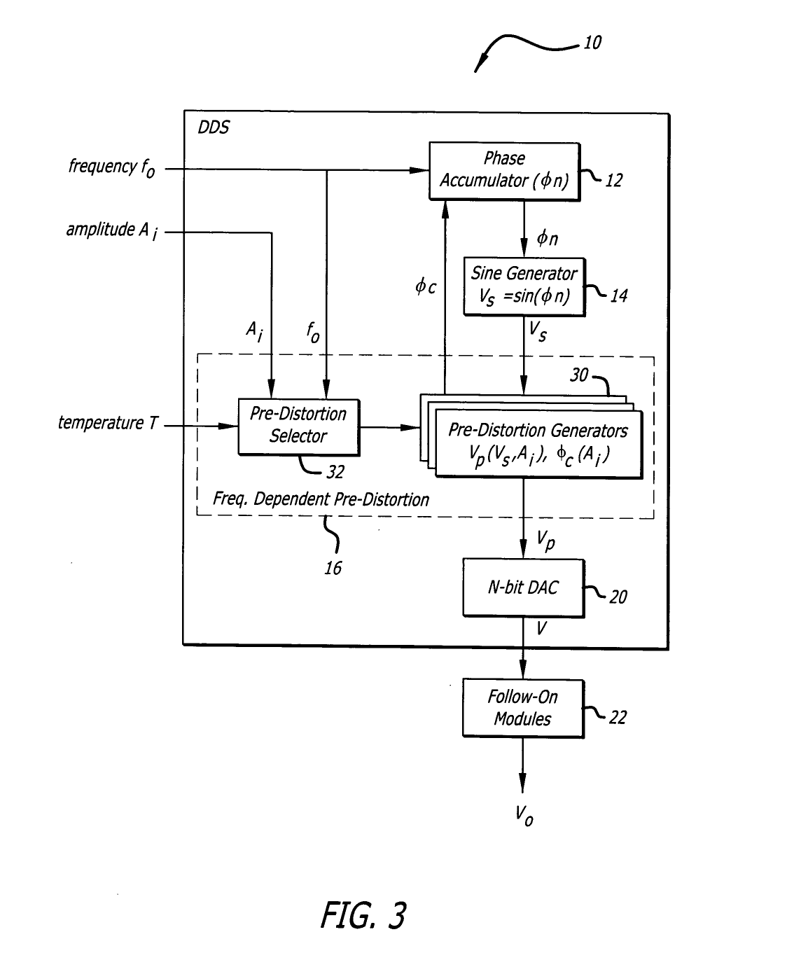

FIG. 3 is a simplified block diagram of a DDS 10 with frequency dependent pre-distortion designed in accordance with an illustrative embodiment of the present invention. The inputs to the DDS 10 include a frequency fₒ, an input amplitude Aᵢ, and, optionally, a temperature T. The DDS 10 includes a phase accumulator 12, a sine generator 14, a novel frequency dependent pre-distortion unit 16, and a digital-to-analog converter 20.

The phase accumulator 12 outputs a sequence of phase values φₙ in accordance with the input frequency fₒ, given by:

$${φ}_{n} = 2 π {f}_{o} \frac{n}{{f}_{c}} + {φ}_{c} \qquad [ 1 ]$$

where f_{c} is a system clock frequency and φ_{c} is a phase correction factor generated by the pre-distortion unit 16 to provide AM/PM compensation.

The sine generator 14 receives the phase φₙ and generates a digital signal Vₛ given by:

Vₛ=sin(φₙ) [2]

The novel frequency dependent pre-distortion unit 16 receives the input frequency fₒ, the input amplitude Aᵢ, and the sine generator output Vₛ, and outputs a digital pre-distorted signal Vₚ, which is generated from the appropriate values of Vₛ and Aᵢ. The pre-distortion unit 16 also supplies the phase offset φ_{c} as a function of Aᵢ for use by the phase accumulator 12. The digital pre-distorted signal Vₚ is then converted to an analog signal V by a DAC 20. In addition to the DDS 10, there may also be follow-on modules 22, such as upconverters and power amplifiers, which receive the signal output from the DAC 20 and eventually output a signal Vₒ.

The pre-distortion unit 16 can be adapted to compensate for both V(Vₚ) non-linearities in the DAC 20, and Aₒ(Aᵢ) and φ(Aᵢ) non-linearities in the follow-on RF modules 22. In the illustrative embodiment shown in FIG. 3, the pre-distortion unit 16 is designed to output a pre-distorted signal Vₚ that compensates for instantaneous voltage distortion V(Vₚ) from the DAC 20 and AM/AM distortion Aₒ(Aᵢ) from the follow-on modules 22, and a phase correction offset φ_{c} that compensates for AM/PM distortion φ(Aᵢ) from the follow-on modules 22. In this embodiment, the input amplitude Aᵢ is changed in response to known factors or commands in the follow-on analog modules 22 external to the DDS 10. Thus, the DDS 10 compensates for IMD due to AM/AM and AM/PM from variations Aᵢ external to the DDS 10, as well as IMD generated by the instantaneous variations Vₛ due to the DDS itself.

In accordance with an illustrative embodiment of the present invention, the frequency dependent pre-distortion unit 16 includes a plurality of pre-distortion generators 30 and a pre-distortion selector 32 for selecting one of the pre-distortion generators 30 depending on the input frequency fₒ. Each pre-distortion generator 30 provides non-frequency dependent pre-distortion, which is a function of the input amplitude Aᵢ and the sine table value Vₛ, for a particular frequency sub-band of the overall system bandwidth. The pre-distortion selector 32 receives the frequency fₒ of the signal and selects which pre-distortion generator 30 to use depending on the frequency fₒ. The pre-distortion unit 16 may also be designed to compensate for temperature dependent non-linearities. In this case, each pre-distortion generator 30 would cover a particular frequency sub-band and temperature band, and the pre-distortion selector 32 would be adapted to receive the frequency fₒ and the temperature T and select one of the pre-distortion generators 30 depending on those two parameters.

Each pre-distortion generator 30 is adapted to receive the sine generator output Vₛ and the input amplitude Aᵢ, and apply a non-frequency dependent pre-distortion function to generate the pre-distorted signal Vₚ and the phase offset φ_{c}. In the illustrative embodiment, the pre-distortion generators 30 are implemented digitally using look-up tables. Each digital pre-distortion generator 30 includes a look-up table, which stores pre-distorted output values Vₚ and phase offsets φ_{c} for a plurality of input samples Vₛ and Aᵢ, and logic adapted to receive input values Vₛ and Aᵢ and output a pre-distorted sample Vₚ and phase offset φ_{c} in accordance with the look-up table. The look-up table applies a pre-distortion function calculated for a particular frequency and/or temperature sub-band. The tables can be designed to be uploadable to allow for calibration and future re-adjustments (aging effects). Other implementations of the pre-distortion generators 30 can also be used without departing from the scope of the present teachings. For example, the pre-distortion generator 30 may be implemented using a processor that computes the pre-distortion function as represented by a polynomial algorithm, or other similar mechanization.

In the illustrative embodiment, the look-up tables store pre-distortion values Vₚ(Vₛ) to the nearest DAC least significant bit (LSB). Correction is only limited by the DAC resolution. The mean square quantization error in full scale (FS) units for an N-bit DAC would then be given by:

$${σ}^{2} = ( \frac{2}{3} ) {2}^{- 2 N} \qquad [ 3 ]$$

Assuming full scale osculating sine wave and all power in one spur gives a spur reduction of:

$${P}_{spur} / {P}_{o} = {σ}^{2} = ( \frac{2}{3} ) {2}^{- 2 N} \qquad [ 4 ]$$

where Pₛₚᵤᵣ is the power in the spur and Pₒ is the overall output power.

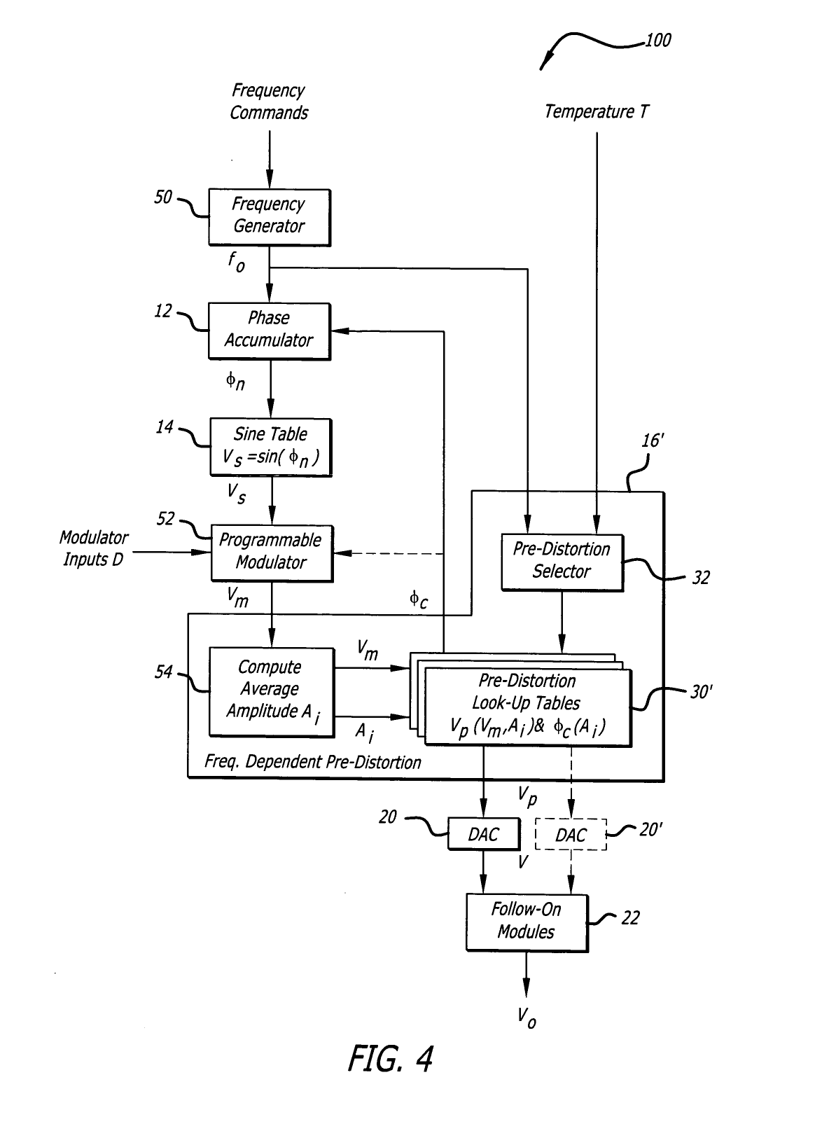

FIG. 4 is a simplified block diagram of a direct digital synthesizer and modulator system 100 with frequency and temperature dependent pre-distortion designed in accordance with an illustrative embodiment of the present invention. In this embodiment, frequency and temperature dependent pre-distortion is provided to compensate for both AM/AM and AM/PM distortion, but the input amplitude Aᵢ is generated internally. The digital inputs to the system 100 include frequency commands, temperature words T, and modulator input words D. The system 100 may also include a clock signal at frequency f_{c} (not shown for simplicity) that drives the digital sections of the invention.

The system 100 includes a frequency generator 50, a DDS section comprising a phase accumulator 12 and sine generator 14, a modulator 52, a frequency dependent pre-distortion unit 16′ designed in accordance with the present teachings, a DAC 20, and follow-on modules 22. The frequency generator 50 includes digital components to generate a sequence of digital words representing the frequency fₒ of the desired output waveform (i.e. a chirp or frequency hopped signal). Frequency generators are well known in the art and can be programmable to allow for multiple applications. The phase accumulator 12 generates a phase word φₙ at the nth clock period 1/f_{c} in accordance with the frequency fₒ given by Eqn. 1. The phase φₙ drives the sine generator 14, which produces a voltage word Vₛ given by Eqn. 2. In the illustrative embodiment, the sine generator 14 is implemented using a look-up table. Other implementations may also be used without departing from the scope of the present teachings.

The programmable modulator 52 uses the data input words D to modulate Vₛ with an appropriately programmed waveform to produce digital modulation voltage words Vₘ. In communications applications, for example, Vₘ can include BPSK (binary phase-shift keying) or QPSK (quadrature phase-shift keying) modulation waveforms. In radar applications, Vₘ may include pulsed, ramped, or frequency hopped sine waves. The modulator can use either real modulation or complex modulation. In real modulation, a real-valued Vₘ is produced, which represents a real-valued carrier sine wave at fₒ multiplied by the modulation envelope. In complex modulation, a complex-valued Vₘ is produced, which represents a complex-valued carrier exponential at fₒ multiplied by the modulation envelope. For complex modulation, the AM/PM pre-distortion correction φ_{c}(Aᵢ) can be applied here, rather than in the phase accumulator 12.

The frequency dependent pre-distortion unit 16′ includes a plurality of pre-distortion generators 30′ and a pre-distortion selector 32 for selecting one of the pre-distortion generators 30′ depending on the frequency fₒ and temperature T. In the illustrative embodiment, the pre-distortion generators 30′ are implemented using a plurality of digital look-up tables. Each pre-distortion generator 30′ includes pre-distortion tables for amplitude correction Vₚ(Vₘ, Aᵢ) and phase correction φ_{c}(Aᵢ) for a particular frequency range and temperature range.

In this embodiment, the pre-distortion unit 16′ also includes a compute average amplitude unit 54. The compute average amplitude unit 54 generates an input amplitude Aᵢ averaged over several output frequency fₒ cycles. This process is well known in the art and can output a value Aᵢ every clock cycle by using a stepped digital filter. The digital pre-distortion tables 30′ utilize both Vₘ and Aᵢ to produce a pre-distorted instantaneous voltage word Vₚ(Vₘ, Aᵢ). This compensates for both instantaneous voltage distortions in the DAC 20 and AM/AM non-linearities in the follow-on modules 22. The tables 30′ also produce phase correction φ_{c}(Aᵢ) for use in the phase accumulator 12 or modulator 52 to compensate for AM/PM non-linearities in the follow-on modules 22. Generally, a large number of tables will be unnecessary because the non-linear properties of both DACs and follow-on modules change slowly over frequency and temperature.

The DAC 20 is adapted to convert the pre-distorted signal Vₚ to an analog signal V. For real modulation, the DAC output signal V is a single analog voltage that represents a pre-distorted modulated sine wave. For complex modulation, the system 100 includes two DACs 20 and 20′, which operate on the in-phase and quadrature-phase components of the pre-distorted signal Vₚ to produce two analog voltages that represent a pre-distorted modulated complex envelope. This complex envelope can be upconverted using a linear in-phase/quadrature mixer to produce a real RF output at much higher frequencies. The complex approach is used to simplify the upconversion process.

The designs described herein should allow persons of ordinary skill in the art of producing discrete circuit boards, application specific integrated circuits (ASICs) and/or programmable logic devices (PLDs) to reduce the above invention to practice without undue experimentation. The building blocks utilized in the design descriptions herein, such as DDSs, modulators, look-up tables, and DACs, are well known in the art. The present application provides a teaching as to how these well-known building blocks can be combined to provide the functionality of the devices described herein. It is also well known in the art that such reduction to practice can be aided by the use of design tools available from multiple manufacturers. These software tools can convert the conceptual level designs described herein, after the selection of operating frequencies, modulation formats, etc., depending on the specific embodiment desired, into discrete circuit designs, ASIC masks, and PLD interconnect lists. These can be reduced to practice using well-known fabrication techniques and electronic device technologies and components.

Thus, the present invention has been described herein with reference to a particular embodiment for a particular application. Those having ordinary skill in the art and access to the present teachings will recognize additional modifications, applications and embodiments within the scope thereof. For example, while the invention has been described with reference to direct digital synthesizers and modulators, the invention is not limited thereto. The novel pre-distortion techniques described can be applied to other applications without departing from the scope of the present teachings.

It is therefore intended by the appended claims to cover any and all such applications, modifications and embodiments within the scope of the present invention.

Accordingly,

What is claimed is:

1. A pre-distortion device comprising:
a plurality of pre-distortion generators, each pre-distortion generator adapted to receive an input signal and output a pre-distorted signal and
first means for selecting one of said pre-distortion generators in accordance with a frequency of said input signal and/or a temperature.

2. The invention of claim 1 wherein each pre-distortion generator is adapted to compensate for distortions produced in a particular frequency range and/or temperature range.

3. The invention of claim 2 wherein said first means selects a pre-distortion generator having a frequency range and/or temperature range that includes said frequency and/or temperature.

4. The invention of claim 1 wherein said pre-distorted signal compensates for amplitude distortions.

5. The invention of claim 4 wherein each pre-distortion generator is also adapted to output a phase correction signal for compensating for phase distortions.

6. The invention of claim 5 wherein said pre-distortion device further includes second means for computing an average amplitude of said input signal.

7. The invention of claim 6 wherein said phase correction signal is a function of said average amplitude.

8. The invention of claim 6 wherein said pre-distorted signal is a function of said input signal and said average amplitude.

9. The invention of claim 1 wherein said pre-distortion generators are implemented using digital look-up tables.

10. A frequency dependent pre-distortion device for agile frequency systems comprising:
a plurality of non-frequency dependent pre-distortion look-up tables, each table covering a particular frequency range and adapted to receive an input signal and output a pre-distorted signal, and
a pre-distortion selector adapted to receive a signal representing a frequency of said input signal and in accordance therewith, select one of said pre-distortion tables that covers a frequency range that includes said frequency.

11. The invention of claim 10 wherein said pre-distorted signal compensates for amplitude distortions.

12. The invention of claim 10 wherein each table is also adapted to output a phase correction signal for compensating for phase distortions.

13. The invention of claim 12 wherein said pre-distortion device further includes a mechanism for computing an average amplitude of said input signal.

14. The invention of claim 13 wherein said phase correction signal is a function of said average amplitude.

15. The invention of claim 13 wherein said pre-distorted signal is a function of said input signal and said average amplitude.

16. The invention of claim 10 wherein said each table covers a particular frequency range and a particular temperature range.

17. The invention of claim 16 wherein said pre-distortion selector is also adapted to receive a signal representing a temperature and in accordance with said temperature and said frequency, select one of said pre-distortion tables that covers a frequency range that includes said frequency and temperature range that includes said temperature.

18. A direct digital synthesizer comprising:
a phase accumulator adapted to receive a frequency signal and in accordance therewith output a sequence of phase words;
a sine generator adapted to apply a sine function to said phase words and output a digital signal;
a plurality of pre-distortion generators, each pre-distortion generator adapted to receive said digital signal and output a pre-distorted signal; and
a pre-distortion selector adapted to receive said frequency signal and in accordance therewith, select one of said pre-distortion generators.

19. The invention of claim 18 wherein each pre-distortion generator is adapted to compensate for distortions produced in a particular frequency range.

20. The invention of claim 19 wherein said pre-distortion selector is adapted to select a pre-distortion generator having a frequency range that includes said frequency.

21. The invention of claim 18 wherein each pre-distortion generator also covers a particular temperature range.

22. The invention of claim 21 wherein said pre-distortion selector is also adapted to receive a temperature signal and select a pre-distortion generator having a frequency range that includes said frequency and a temperature range that includes said temperature.

23. The invention of claim 18 wherein said direct digital synthesizer further includes a digital to analog converter adapted to convert said pre-distorted signal into an analog signal.

24. The invention of claim 23 wherein said pre-distorted signal compensates for instantaneous voltage distortions produced by said digital to analog converter.

25. The invention of claim 23 wherein said direct digital synthesizer further includes one or more analog radio frequency modules following said digital to analog converter.

26. The invention of claim 25 wherein said pre-distorted signal compensates for amplitude to amplitude distortions produced by said analog radio frequency modules.

27. The invention of claim 26 wherein each pre-distortion generator is also adapted to output a phase correction signal for compensating for amplitude to phase distortions produced by said analog radio frequency modules.

28. The invention of claim 27 wherein said direct digital synthesizer further includes a modulator for modulating said digital signal output by said sine generator.

29. The invention of claim 28 wherein said direct digital synthesizer further includes a mechanism for computing an average amplitude of said digital signal.

30. The invention of claim 29 wherein said phase correction signal is a function of said average amplitude.

31. The invention of claim 29 wherein said pre-distorted signal is a function of said digital signal and said average amplitude.

32. The invention of claim 18 wherein said pre-distortion generators are implemented using digital look-up tables.

33. A pre-distortion generator comprising:
a first circuit for storing a pre-distortion function calculated for a particular frequency and/or temperature band and
a second circuit for receiving an input signal and applying said pre-distortion function to said input signal to produce a pre-distorted output signal.

34. The invention of claim 33 wherein said first circuit includes one or more look-up tables.

35. The invention of claim 33 wherein said pre-distortion function corrects for an amplitude distortion in said frequency and/or temperature band.

36. The invention of claim 35 wherein said first circuit is also adapted to store a phase correction function for correcting a phase distortion in said frequency and/or temperature band.

37. The invention of claim 36 wherein said second circuit is also adapted to output a phase correction signal in accordance with said phase correction function.

38. A pre-distortion generator for a direct digital synthesizer comprising:
a look-up table adapted to store pre-distorted output values for a plurality of input samples and
a circuit for receiving a sequence of input samples and outputting a sequence of distorted output samples in accordance with said look-up table.

39. The invention of claim 38 wherein said look-up table applies a pre-distortion function to said input samples to compensate for an amplitude distortion.

40. The invention of claim 39 wherein said pre-distortion function is calculated for a particular frequency and/or temperature band.

41. The invention of claim 40 wherein said pre-distortion generator further includes a second look-up table adapted to store phase correction samples as a function of input samples for correcting a phase distortion.

42. The invention of claim 41 wherein said circuit is also adapted to output a phase correction signal in accordance with said second look-up table.

43. A method for providing frequency and/or temperature dependent pre-distortion including the steps of:
providing a plurality of pre-distortion generators, each pre-distortion generator covering a particular frequency range and/or temperature range and adapted to receive an input signal and output a pre-distorted signal and
selecting one of said pre-distortion generators in accordance with a frequency of said input signal and a temperature.
